(19) United States
(12) Patent Application Publication
(10) Pub. No.: US 2017/0369314 A1
(43) Pub. Date: Dec. 28, 2017

(54) POLYCRYSTALLINE CUBIC BORON NITRIDE (PCBN) COMPRISING MICROCRYSTALLINE CUBIC BORON NITRIDE (CBN) AND METHOD OF MAKING

(71) Applicant: DIAMOND INNOVATIONS, INC., Worthington, OH (US)

(72) Inventors: Kai ZHANG, Westerville, OH (US); Suresh VAGARALI, Columbus, OH (US)

(21) Appl. No.: 15/540,787

(22) PCT Filed: Dec. 31, 2015
(86) PCT No.: PCT/US2015/068239

§ 371 Date: Jun. 29, 2017

Related U.S. Application Data
(60) Provisional application No. 62/099,142, filed on Dec. 31, 2014.

(51) Int. Cl. C01B 21/064; C04B 35/5831; C04B 35/645; C04B 37/02; C04B 35/626; C04B 35/63

(52) U.S. Cl. CPC C01B 21/064; C04B 35/62675; C04B 35/6268; C04B 35/6303; C04B 35/645; C04B 37/021; C04B 35/5831; C04B 2235/5436; C04B 2235/3886; C04B 2235/3865; C04B 2235/3856; C04B 2235/3843; C04B 2235/549; C04B 2235/6565; C04B 2235/72; C04B 2235/85; C04B 2235/963; C04B 2237/40; C04B 2237/361

(57) ABSTRACT

Polycrystalline cubic boron nitride compact include a body having sintered microcrystalline cubic boron nitride in a matrix of binder material. The microcrystalline cubic boron nitride particles have a size ranging from 2 microns to 50 microns. The particles of microcrystalline cubic boron nitride include a plurality of sub-grains, each sub-grain having a size ranging from 0.1 micron to 2 microns. The compacts are manufactured in a high pressure—high temperature (HPHT) sintering process. The compacts exhibit intergranular defect formation following introduction of wear. The sub-grains promote crack propagation based on micro-chipping rather than on a cleavage mechanism and, in sintered bodies, cracks propagate intergranularly rather than intragranularly, resulting in increased toughness and improved wear characteristics as compared to monocrystalline cubic boron nitride. The compacts are suitable for use as abrasive tools.

### CROSS-REFERENCE TO RELATED APPLICATIONS

None

### TECHNICAL FIELD AND INDUSTRIAL APPLICABILITY

The present disclosure relates generally to polycrystalline cubic boron nitride (PcBN). Specifically, the present disclosure relates to preparing polycrystalline cubic boron nitride powders and methods of processing such polycrystalline cubic boron nitride powders into abrasive tools. The polycrystalline cubic boron nitride powders exhibit a multicrystalline grain structure in which the particles of polycrystalline cubic boron nitride each contain numerous sub-grains and the abrasive tools made with such polycrystalline cubic boron nitride powders preserve the multicrystalline grain structure.

### BACKGROUND

In the discussion that follows, reference is made to certain structures and/or methods. However, the following references should not be construed as an admission that these structures and/or methods constitute prior art. Applicant expressly reserves the right to demonstrate that such structures and/or methods do not qualify as prior art against the present invention.

The cubic form of boron nitride (cubic boron nitride (cBN)) is useful as an abrasive material. One such use is as particles agglomerated together using bonding systems to form an abrasive tool such as a grinding wheel. For application as an abrasive material, particularly in cutting tools, it is desirable that the cubic boron nitride contribute to, or at least not deleteriously effect, the abrasion, wear and chipping properties. Other uses include honing, dicing, and polishing.

Machining requires the cutting tool possess high abrasion properties, low wear and chipping, and long life times. Ideally, the tool failure mode is abrasion wear only, rather than any fractures in binder and/or cubic boron nitride feeds induced by propagation of micro or macro cracks. Conventional cubic boron nitride-based tools utilize monocrystalline cubic boron nitride powders, in which each cubic boron nitride particle is a single grain. The single grain structure influences the failure mode of tools made from monocrystalline cubic boron nitride feeds because crack propagation, both micro and macro cracks, can occur not only as fractures in the binder but also by cleavage of the monocrystalline cubic boron nitride grain. Both of these failure mechanisms contribute to reduce the performance of abrasive tools made from monocrystalline cubic boron nitride powders.

Sintering cubic boron nitride involves high pressure-high temperature (HPHT) processes, but technological improvements in sintering this type of material have focused largely on the study of binder phases and there has been little research into the cubic boron nitride feed and how the cubic boron nitride powders in the feed impact the sintering and ultimate performance of the sintered product, particularly in machining applications

It would be beneficial in cubic boron nitride-based abrasive tools to identify improvements in the cubic boron nitride material that contribute to improved abrasion performance and impact toughness.

### SUMMARY

Cubic boron nitride can be synthesized as microcrystalline mesh or micron particles that are composed of multiple sub-grains in micron or submicron (micrometer) sizes separated by grain boundaries, so called microcrystalline cubic boron nitride. See, e.g., U.S. Pat. Nos. 2,947,617 and 5,985,228, the entire contents of which are incorporated herein by reference. Microcrystalline cubic boron nitride has increased toughness over monocrystalline cubic boron nitride. Other advantageous properties of microcrystalline cubic boron nitride may include i) increased purity of cubic boron nitride grains without residual metallic catalysts and/or impurities; ii) higher toughness than standard monocrystalline cubic boron nitride powder; iii) crack propagation mode based on micro-chipping rather than on a cleavage mechanism; iv) in sintered bodies, cracks propagate intergranularly rather than intragranularly; and v) blocky crystal shapes with rough surface textures. Abrasive tools having a microstructure that includes multicrystalline cubic boron nitride grains contain numerous sub-grains separated by grain boundaries that impart improved abrasion performance and impact toughness.

In one embodiment, a polycrystalline cubic boron nitride compact includes a body having sintered microcrystalline cubic boron nitride in a matrix of binder material. The microcrystalline cubic boron nitride particles have a size ranging from 2 microns to 50 microns. The particles of microcrystalline cubic boron nitride include a plurality of sub-grains, each sub-grain having a size ranging from 0.1 micron to 2 microns.

In another embodiment a method of manufacturing a polycrystalline cubic boron nitride compact includes blending microcrystalline cubic boron nitride particles with a binder material under a controlled atmosphere to form a powder blend, assembling the blend into a cell structure for use in a high pressure—high temperature (HPHT) sintering process, and sintering the blend to form the polycrystalline cubic boron nitride compact by applying high pressure and high temperature to the assembly. The polycrystalline cubic boron nitride compact includes a body including sintered microcrystalline cubic boron nitride in a matrix of binder material. The microcrystalline cubic boron nitride are particles having a size ranging from 2 microns to 50 microns. The particles of microcrystalline cubic boron nitride include a plurality of sub-grains, each sub-grain having a size ranging from less than 0.1 micron to 2 microns.

### BRIEF DESCRIPTION OF THE DRAWINGS

The foregoing summary, as well as the following detailed description of the embodiments, will be better understood when read in conjunction with the appended drawings. It should be understood that the embodiments depicted are not limited to the precise arrangements and instrumentalities shown.

FIGS. 1A and 1B are scanning electron microscopy (SEM) micrographs of an exemplary embodiment of microcrystalline cubic boron nitride particles.

FIGS. 2A and 2B are scanning electron microscopy (SEM) micrographs of monocrystalline cubic boron nitride particles.

FIGS. 3A and 3B show example geometries of supported compacts and unsupported compacts that incorporate sintered bodies of polycrystalline cubic boron nitride particles.

FIG. 4A is a scanning electron microscopy (SEM) micrograph showing the microstructure of a sample compact made with microcrystalline cubic boron nitride particles.

FIG. 4B is a scanning electron microscopy (SEM) micrograph showing the microstructure of a sample compact made with monocrystalline cubic boron nitride particles.

FIGS. 5A and 5B are magnified scanning electron microscopy (SEM) micrograph of the microstructures shown in FIGS. 4A and 4B, respectively.

### DETAILED DESCRIPTION

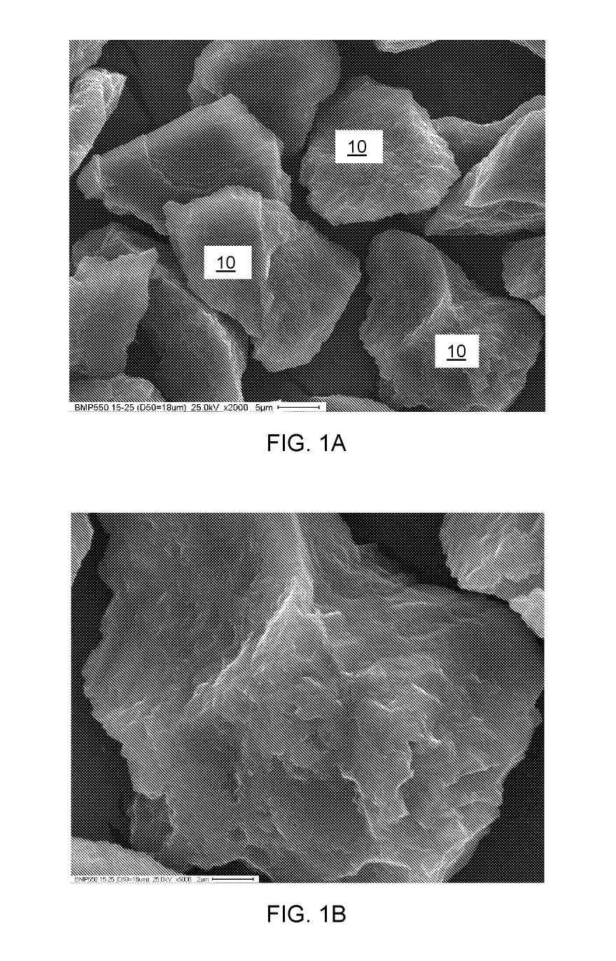

FIGS. 1A and 1B are scanning electron microscopy (SEM) micrographs of an exemplary embodiment of polycrystalline cubic boron nitride particles. FIG. 1A shows a number of microcrystalline cubic boron nitride particles 10 at 2000× magnification. The microcrystalline cubic boron nitride particles have a D50 value of particle size of 18 microns. X-ray fluorescence (XRF) on the microcrystalline cubic boron nitride particles 10 indicates they have a composition that is essentially boron and nitride, with impurity levels of Co (8 ppm), Cr (10 ppm), Fe (69 ppm), Ni (25 ppm) and Si (19 ppm). These impurities are from milling media introduced to the cubic boron nitride particles during a milling process used to make such microcrystalline particles.

Microcrystalline cubic boron nitride particles can be synthesized as mesh or micron particles that are composed of multiple sub-grains in micron or submicron (micrometer) sizes and separated by grain boundaries. See, e.g., U.S. Pat. Nos. 2,947,617 and 5,985,228, the entire contents of which are incorporated herein by reference.

The microcrystalline cubic boron nitride particles 10 have an irregular shape and a very rough surface texture. This surface texture is more readily seen in FIG. 1B, which is an SEM micrograph of a microcrystalline cubic boron nitride particle at 5000× magnification (specifically of the microcrystalline cubic boron nitride particle 10 in the lower left corner of the micrograph in FIG. 1A). In FIG. 1B, the microcrystalline cubic boron nitride particle 10 is irregular with non-linear edges and multiple height changes, both of which are indicative of a multi-crystalline body (i.e., a microcrystalline body) and which is correlated to surface termination of the individual crystalline grains in the microcrystalline body. The height of the surface texture of each microcrystalline particle is determined by ½ of the grain size of the sub-grain exposed on the particle surface.

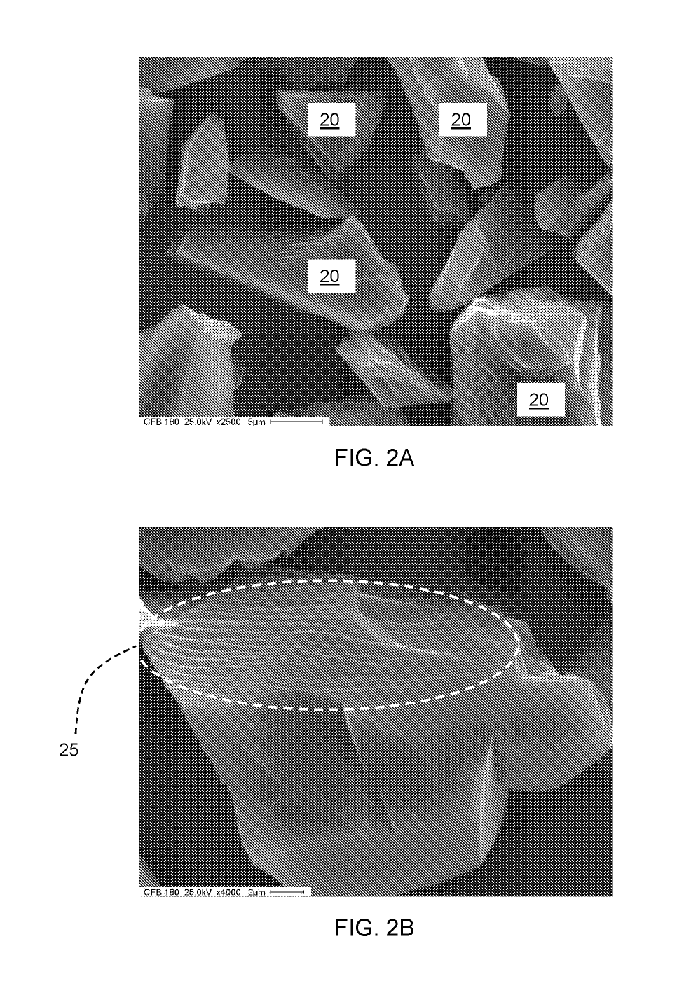

As a comparison to the microcrystalline cubic boron nitride particles 10, monocrystalline cubic boron nitride particles were observed under scanning electron microscopy. FIGS. 2A and 2B are scanning electron microscopy (SEM) micrographs of an exemplary embodiment of monocrystalline cubic boron nitride particles. FIG. 2A shows a number of monocrystalline cubic boron nitride particles 20 at 2500× magnification. The monocrystalline cubic boron nitride particles have a D50 value of 18 microns. The monocrystalline cubic boron nitride particles 20 have a smooth and faceted surface texture indicative of surfaces that have fractured along crystal planes of the monocrystalline structure. This surface texture is more readily seen in FIG. 2B, which is an SEM micrograph of a monocrystalline cubic boron nitride particles 20 at 4000× magnification and also shows the layering of crystal planes in region 25.

The microcrystalline particles present very rough looking and blocky shapes with comparatively less straight crystal edges, while the monocrystalline particles show mixed rough and smooth looking and angular shapes with straight edges.

Microcrystalline cubic boron nitride particles can be used as the feed for manufacturing a sintered polycrystalline cubic boron nitride compact, either as a supported compact or an unsupported compact. In exemplary manufacturing processes, microcrystalline cubic boron nitride particles are blended with a binder material under a controlled atmosphere, such as an inert atmosphere, to form a powder blend. The microcrystalline cubic boron nitride particles range can range in size from 1 microns to 50 microns, alternatively from 2 microns to 20 microns, alternatively about 18 microns, where the size is reported as the D50 value of particle size. The composition of the powder blend can include from 0 to 50 weight percent (wt %) binder, alternatively from 10 to 40 wt %. Suitable binder materials include nitrides, carbides, and carbonitrides of Ti, Al, and Zr, for example, TiN, TiC, Ti(C,N), ZrN, AlN, as well as Co and Al, and mixtures thereof.

The powder blend is then assembled into a cell structure for use in a high temperature—high pressure (HPHT) sintering process as is known in the art. See for example, U.S. Pat. No. 3,767,371, the entire contents of which are incorporated herein by reference. As an example of a HPHT sintering process, the powder blend may optionally be distributed in contact with a face of a substrate, such as a hard sintered carbide disc. The powder-substrate combination is enclosed in a thin zirconium shield, such as a container or a metal wrapping, either of which encapsulates the powder and the optional substrate to exclude and remove oxygen. This assembly can then be surrounded in turn by high pressure transferring elements, for example, NaCl-based elements, to form a HPHT cell. Multiple assemblies can be combined within the HPHT cell. The HPHT cell can then be placed in a HPHT sintering apparatus and high pressure and high temperature (5.5-7 GPa, preferably 6 GPa, and 1,300° C. to 1,800° C., preferably 1,500° C.) can then be applied for a suitable period of time to sinter the powder blend and adhere the sintered powder blend to the face of the optional substrate. Typical HPHT process time periods range from 30 minutes to 4 hours. After removing the pressure and allowing the HPHT cell to cool, a composite abrasive body can be recovered.

An optional step in which the microcrystalline cubic boron nitride particles are pre-treated can be included in the above manufacturing processes prior to blending the microcrystalline cubic boron nitride particles with a binder material. The pre-treatment step includes heating the microcrystalline cubic boron nitride particles in a furnace at a temperature of 500° C. to 1,300° C., preferably 900° C., in an ammonia atmosphere for not more than 2 hours, preferably from 1 to 2 hours. The temperature and time can vary within these ranges with shorter times being used with higher temperatures and longer times being used with lower temperatures. The pre-treatment step cleans the surfaces of the microcrystalline cubic boron nitride particles of any contaminants. To help maintain the cleaned surface, the pre-treated microcrystalline cubic boron nitride particles are stored and transported to subsequent manufacturing processes in an inert gas environment. Further and as described hereinabove, when the pre-treated microcrystalline cubic boron nitride particles are blended with a binder material, the blending process also occurs under a controlled atmosphere, such as conducting the blending process in an inert gas.

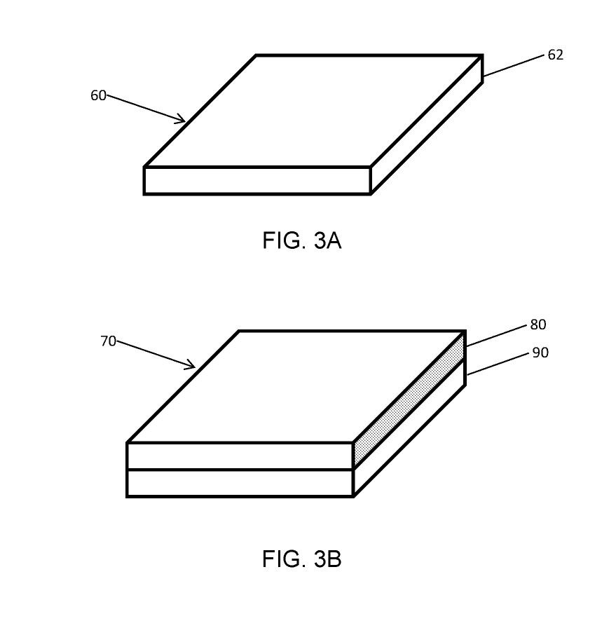

Composite abrasive bodies that include a substrate are known as supported compacts. The manufacturing process discussed hereinabove can also be conducted without the presence of a substrate, in which case the recovered composite abrasive body does not include a substrate. Such a composite abrasive body is known as an unsupported compact. FIGS. 3A and 3B show example geometries of unsupported compacts 60 and supported compacts 70, respectively. Supported compacts 70 include a body 80 including sintered microcrystalline cubic boron nitride in a matrix of binder material. The body 80 is coupled to a substrate 90. The body 80 is integrally bonded to substrate 90 by thermal diffusion of metal phases in the substrate 90 to the interface of sintered microcrystalline cubic boron nitride particles in the body 80. The unsupported compacts 60 include a body 62 including sintered microcrystalline cubic boron nitride in a matrix of binder material. In both the supported compact 70 and the unsupported compact 60, the sintered body includes a plurality of particles. Each of the plurality of particles has a plurality of sub-grains. Each sub-grain has a size ranging from less than 1 micron to 2 microns, alternatively from 0.1 microns to 1.5 microns, as measured by MicroTrac particle characterization system. A typical microcrystalline cubic boron nitride particle with a particle diameter of 1 to 2 microns contains from about 10 to about 5,000 sub-grains, for example, approximately 1000 sub-grains.

A microstructural investigation was conducted on samples of unsupported compacts. One unsupported compact was manufactured using microcrystalline cubic boron nitride particles as the feed for manufacturing via a HPHT process. The other unsupported compact used monocrystalline cubic boron nitride particles as the feed for manufacturing via a HPHT process. The first sample (Sample A) was prepared by loading 6.75 grams of microcrystalline cubic boron nitride (cBN) particles having a D50 value of particle size of 18 microns (available from Sandvik Hyperion as grade BMP 550 15-25) into a refractory tube container. Two pieces of Al disc (0.012″ (0.3 mm) thick) were positioned at both ends of the container and were in contact to the unbonded cBN particles. The container was then sealed by positioning one graphite disc at each end of the refractory tube container such that the graphite discs were in contact with the Al discs, thereby forming a core assembly. Subsequently, the core assembly was incorporated into a high pressure cell and encapsulated by cell components, such as Ta discs and salt pressure transmitting medium pills. High pressure-high temperature (HPHT) sintering was conducted at a pressure of 55 kbar and a soak temperature of 1400° C. for about 20 minutes of dwell time. After the dwell time, the cell was cooled down first at a temperature drop rate of 50° C./min for 4 minutes and then all heating energy was terminated for quick temperature drop using coolants. The formed PcBN body of Sample A had the geometry of standard quadrilateral tool geometry.

For comparison, a second sample (Sample B) was prepared as a baseline and was made using monocrystalline cubic boron nitride (cBN) particles having particle size D50 of 18 micrometers (available from Sandvik Hyperion as grade CFB 180). The second sample was processed using the same HPHT processing conditions as Sample A. Sample A (inventive) differed from Sample B (baseline) in the microstructure of the feed particles, ie. microcrystalline vs monocrystalline. Table 1 summarizes details of the manufacturing process.

TABLE 1

| | | | HPHT | |
|---|---|---|---|---|
| Sample | Composition | Substrate | conditions | Pretreatment |
| A | 90 wt % | Unsupported | P = 5.5 GPa | No |
| | multicrystalline | | T = 1400° C. | |
| | cBN | | t = 20 mins | |
| | (D50 = | | | |
| | 18 microns) | | | |
| | 10 wt % | | | |
| | Al binder | | | |
| B | 90 wt % | Unsupported | P = 5.5 GPa | No |
| | monocrystalline | | T = 1400° C. | |
| | cBN | | t = 20 mins | |
| | (D50 = | | | |
| | 18 microns) | | | |
| | 10 wt % | | | |
| | Al binder | | | |

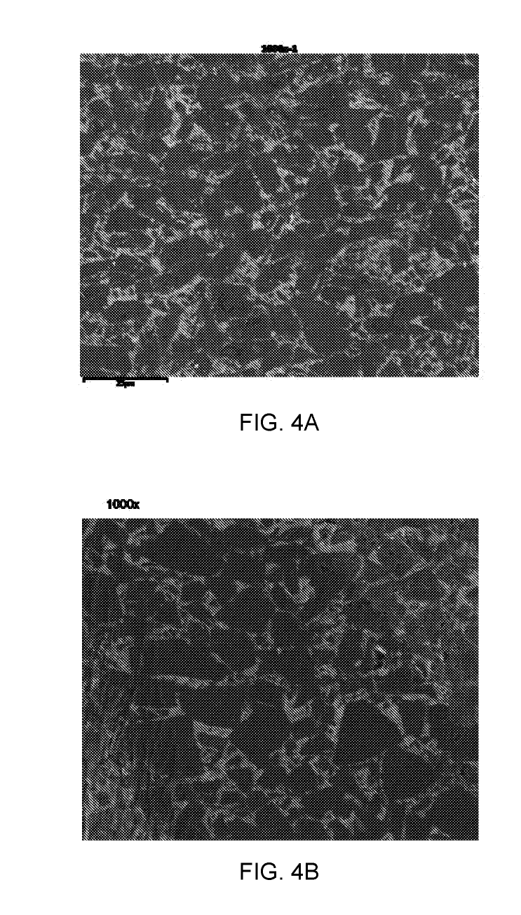

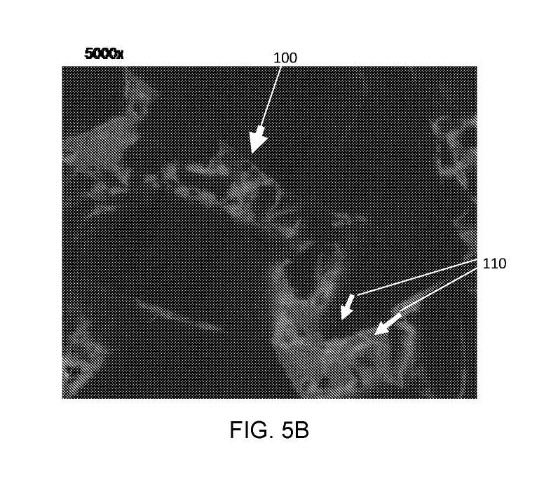

Sample A is shown in FIG. 4A and Sample B is show in FIG. 4B. Both samples were prepared by fracturing the sample to expose the cross-section of the cubic boron nitride layer, generally along a diameter of the cylindrically shaped sample. Sample A (inventive) and Sample B (baseline) were then further prepared for structural characterization using SEM by cross-section lapping and polishing followed by ion beam milling as the final step.

The microstructure of Samples A and B made in accordance with the details above were investigated using scanning electron microscopy (SEM). The SEM equipment used was HITACHI S4500 and the settings were 25 KV voltage and 12 mm working distance. FIG. 4A is an SEM micrograph showing the microstructure of Sample A and FIG. 4B is a SEM micrograph showing the microstructure of Sample B. Both FIGS. 4A and 4B are at 1000× magnification and the length bar in FIG. 4A applies equally to FIG. 4B.

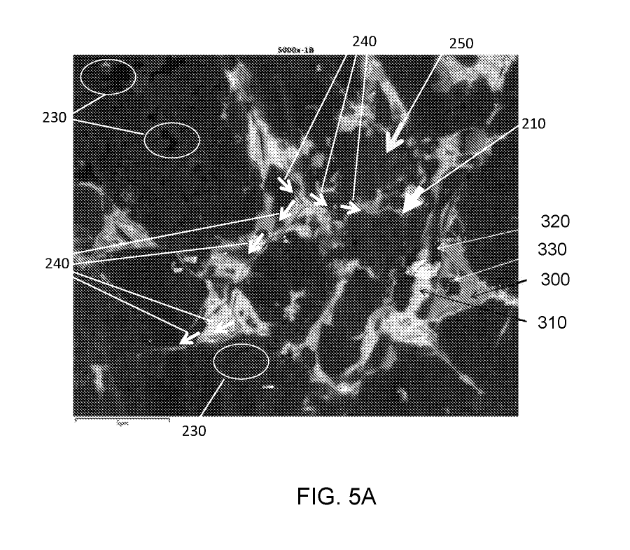

The micrographs in FIGS. 4A and 4B show similar general sintering features. In both micrographs, coarse cubic boron nitride particles are separated by both fine cubic boron nitride particles (shown in black) and binder phases (shown in gray and white). Overall, the sintered particles size in Sample A is slightly smaller than the sintered particles size in Sample B. Moreover, the sintered interface between cBN particles and the binder phases of Sample A (FIG. 5A indicated by an arrow labeled 210) is rougher than that of Sample B (FIG. 5B indicated by an arrow labeled 100). In these micrographs, the roughness is determined by the surface texture of the sintered cBN grains. Micro-cracks in the sintered body were observed for both samples. These cracks were induced by fracturing the sample for cross-section view, as seen in the arrows labeled 240 in FIG. 5A and the arrows labeled 110 in 5B.

FIGS. 5A and 5B are magnified micrographs of the microstructures shown in FIGS. 4A and 4B, and are for Sample A and Sample B, respectively. These micrographs are at 5000× magnification and, although the sintered PcBN grains can be clearly distinguished, there are microstructural differences between Sample A and Sample B. Firstly, the sintered particles in Sample A (FIG. 5A) are blockier in shape than the sintered particles in Sample B (FIG. 5B). Secondly, the contrast of the microcrystalline grains (sub-grains) inside each individual sintered grain in Sample A can be clearly observed, as indicated by the arrow labeled 250 in FIG. 5A. Moreover, each microcrystalline grain also includes pits or voids on the surface, which are indicated by circles labeled 230 in FIG. 5A. The dimensions of the voids or pits are in the nanometer range. These pits or voids mechanically improve retention of the cBN in the binder phases when the cBN is processed into a polycrystalline body. In FIG. 5B, each of the monocrystalline cubic boron nitride particles in the micrograph is substantially uniformly dark with no variations in shading or contrast, therefore indicating that no subgrains are present in the sintered monocrystalline cubic boron nitride particles. Thirdly, in Sample A (FIG. 5A), the interfaces between the microcrystalline cubic boron nitride particles and the binder are rougher than those in Sample B (FIG. 5B). The relative increase in roughness of between the microcrystalline cBN particles and the binder is due to the presentence of surface morphology of microcrystalline cBN used in Sample A. In these micrographs, roughness is determined to be about ½ of the cBN sub-grain sizes.

Lastly, as identified by the arrows labeled 240 in FIG. 5A, a crack exists in the binder phases in Sample A and was caused by cross-section fracturing during sample preparation. The crack propagated intergranularly around individual microcrystalline cubic boron nitride particles, rather than intragranularly and through the microcrystalline cubic boron nitride particles. The crack propagation path is indicated by the arrows 240 overlaying the micrograph. This intergranular crack propagation behavior is different than what was observed in monocrystalline cubic boron nitride of sample B, in which the crack penetrated through the monocrystalline cubic boron nitride particles to break the monocrystalline cubic boron nitride particles, i.e., the crack propagated intragranularly. Given the fact that Sample A, which includes microcrystalline cBN grains, is tougher than Sample B, which includes monocrystalline cBN grains, the microcrystalline grains exhibit an ability to terminate the crack penetration by absorbing the crack energy and/or deviating the path of crack propagation.

Compositions of the microstructural features in the sintered polycrystalline cubic boron nitride bodies of Sample A and Sample B were analyzed using EDX. The regions of the microstructure that were investigated are indicated in FIG. 5 and included the following. The grey region (300) was identified as aluminium diboride (AlB₂). The bright region (310) near the AlB₂ was identified as aluminum nitride (AlN). The region (320) between AlB₂ and AlN is cBN phase. Region 330 is an island-like domain inside the AlB₂ region that was also probed and confirmed to be a cBN crystal (see Spectrum 4). Based on the contrast in color, the SEM micrographs qualitatively indicate that there is more AlB₂ phase than AlN phase in the binder region for both Sample A and Sample B. Table 1 summarizes the EDX results for these four regions including the amount (in atomic percent (at. %)) of constituent elements and the identification of the composition of the region.

TABLE 1
EDX Results

| Region in FIG. 5A | B at. % | N at. % | Al at. % | Identity |
|---|---|---|---|---|
| 300 | 69.75 | 0.16 | 30.10 | AlB₂ |
| 310 | 0 | 69.47 | 39.53 | AlN |
| 320 | 52.63 | 46.48 | 0.9 | BN |
| 330 | 52.09 | 46.38 | 1.53 | BN/AlB₂ |

While reference has been made to specific embodiments, it is apparent that other embodiments and variations can be devised by others skilled in the art without departing from their spirit and scope. The appended claims are intended to be construed to include all such embodiments and equivalent variations.

1. A polycrystalline cubic boron nitride compact, comprising:
a body including sintered microcrystalline cubic boron nitride in a matrix of binder material,
wherein the microcrystalline cubic boron nitride are particles having a size ranging from 2 microns to 50 microns, and
wherein the particles of microcrystalline cubic boron nitride include a plurality of sub-grains, each sub-grain having a size ranging from 0.1 micron to 2 microns.

2. The polycrystalline cubic boron nitride compact of claim 1, further comprising a substrate, wherein the body is integrally bonded to the substrate.

3. The polycrystalline cubic boron nitride compact according to claim 1, wherein each sub-grain has a size ranging from 0.5 microns to 1.5 microns.

4. The polycrystalline cubic boron nitride compact according to claim 1, wherein the microcrystalline cubic boron nitride particle contains from about 10 to about 5000 sub-grains.

5. The polycrystalline cubic boron nitride compact according to claim 1, wherein a composition of the body comprises up to 50 wt % binder material.

6. The polycrystalline cubic boron nitride compact of claim 5, wherein the binder material is selected from the group consisting of nitrides, carbides, and carbonitrides of Ti, Al, Zr, Co, Al, and mixtures thereof.

7. The polycrystalline cubic boron nitride compact according to claim 1, wherein the polycrystalline cubic boron nitride compact contains microcrystalline cBN particles having as-grown surface voids or pits and surface texture on the order of a dimension of one half of the subgrains size.

8. A method of manufacturing a polycrystalline cubic boron nitride compact, the method comprising:
blending microcrystalline cubic boron nitride particles with a binder material under a controlled atmosphere to form a powder blend;
assembling the blend into a cell structure for use in a high pressure—high temperature (HPHT) sintering process;
sintering the blend to form the polycrystalline cubic boron nitride compact by applying high pressure and high temperature to the assembly,
wherein the polycrystalline cubic boron nitride compact includes a body including sintered microcrystalline cubic boron nitride in a matrix of binder material,
wherein the microcrystalline cubic boron nitride are particles having a size ranging from 1 microns to 50 microns, and
wherein the particles of microcrystalline cubic boron nitride include a plurality of sub-grains, each sub-grain having a size ranging from less than 0.1 micron to 2 microns.

9. The method of claim 8, wherein the cell structure includes a substrate having a face in contact with the blend and wherein the polycrystalline cubic boron nitride compact includes the substrate and the body that is integrally bonded to the substrate.

10. The method according to claim 8, further comprising, prior to blending the microcrystalline cubic boron nitride particles with the binder material, heating the microcrystalline cubic boron nitride particles to a temperature in a range from 500° C. to 1,300° C., in an ammonia atmosphere, and for a time of not more than 2 hours.

11. The method according to claim 8, wherein each sub-grain has a size ranging from 0.5 microns to 1.5 microns.

12. The method according to claim 8, wherein the microcrystalline cubic boron nitride particle contains from about 10 to about 5000 sub-grains.

13. The method according to claim 8, wherein a composition of the body comprises up to 50 wt % binder material.

14. The method of claim 13, wherein the binder material is selected from the group consisting of nitrides, carbides and carbonitrides of Ti, Al, Zr, Co, Al, and mixtures thereof.

15. The method according to claim 8, wherein the polycrystalline cubic boron nitride compact contains microcrystalline cBN particles having as-grown surface voids or pits and surface texture on the order of a dimension of one half of the subgrains size.
